(19) United States
(12) Patent Application Publication
(10) Pub. No.: US 2003/0005081 A1
(43) Pub. Date: Jan. 2, 2003

(54) Method and apparatus for a passive network-based internet address caching system

(76) Inventor: Preston J. Hunt, Beaverton, OR (US)

Correspondence Address: PILLSBURY WINTHROP, LLP, P.O. BOX 10500, MCLEAN, VA, 22102, US

(21) Appl. No.: 09/893,424

(22) Filed: Jun. 29, 2001

(51) Int. Cl. G06F 15/16; G06F 15/167

(52) U.S. Cl. 709/218; 709/212

(57) ABSTRACT

A method and system for caching web addresses are presented. A network interface monitors traffic on a network. A filter extracts web addresses from the monitored traffic. A database stores the extracted web addresses. A network device queries the database. The query returns zero or more web addresses to the network device. As such, a user of a limited-input network device may access desired web addresses without manually inputting the addresses.

### BACKGROUND

1. Field

This invention relates in general to World Wide Web surfing. More specifically, this invention relates to web surfing on limited-input devices.

2. General Background and Related Art

Network technologies have become increasingly compact and portable in recent years. For instance, Internet tablets, palm computing devices, and cellular phones have become popular. Such devices may interface with a network or a standalone computer, downloading information therefrom or uploading information thereto.

Many limited-input devices support web surfing, wherein a user visits websites available on the World Wide Web (WWW) of the Internet. However, to visit a website, a user of a limited-input device must first input the URL (uniform resource locator) of the desired website. For instance, a tablet user may type the address via an on-screen keyboard. Some devices also support handwriting recognition, wherein a user writes out the address via a stylus. Such input methods are cumbersome and time-consuming.

Therefore, what is needed is a method and system for passive network-based Internet address caching.

### BRIEF DESCRIPTION OF THE DRAWINGS

FIG. 1 is a high-level diagram of a system according to an embodiment of the present invention.

FIG. 2 is a high-level diagram of a caching mechanism according to an embodiment of the present invention.

FIG. 3 is a high-level flow diagram of a method according to an embodiment of the present invention.

FIG. 4 is a high-level flow diagram of a method according to an embodiment of the present invention.

### DETAILED DESCRIPTION

The following detailed description refers to the accompanying drawings that illustrate exemplary embodiments of the present inventions. Other embodiments are possible and modifications may be made to the embodiments without departing from the spirit and scope of the invention. Therefore, the following detailed description is not meant to limit the invention. Rather, the scope of the invention is defined by the appended claims.

It will be apparent to one of ordinary skill in the art that the embodiments as described below may be implemented in many different embodiments of software, firmware, and hardware in the entities illustrated in the figures. The actual software code or specialized control hardware used to implement the present invention is not limiting of the present invention. Thus, the operation and behavior of the embodiments will be described without specific reference to the actual software code or specialized hardware components. The absence of such specific references is feasible because it is clearly understood that artisans of ordinary skill would be able to design software and control hardware to implement the embodiments of the present invention based on the description herein with only a reasonable effort and without undue experimentation.

Moreover, the processes associated with the presented embodiments may be stored in any storage device, such as, for example, a computer system (non-volatile) memory, an optical disk, magnetic tape, or magnetic disk. Furthermore, the processes may be programmed when the computer system is manufactured or via a computer-readable medium at a later date. Such a medium may include any of the forms listed above with respect to storage devices and may further include, for example, a carrier wave modulated, or otherwise manipulated, to convey instructions that can be read, demodulated/decoded and executed by a computer.

A method and system for caching web addresses, as presented herein, involves a network interface. The network interface monitors traffic on a network. A filter extracts web addresses from the monitored traffic. A database stores the extracted web addresses. A network device then queries the database. The query returns zero or more web addresses to the network device. As such, a user of the network device may surf the returned web addresses without manually inputting the addresses.

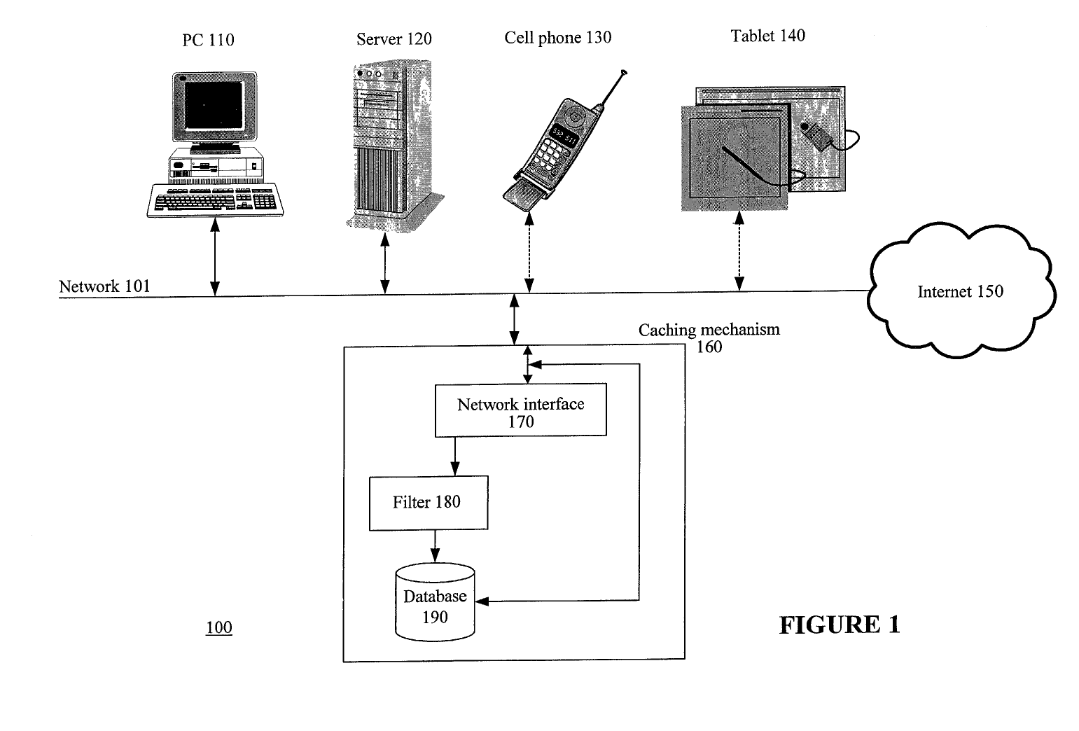

FIG. 1 is a high-level diagram illustrating system 100 according to an embodiment of the present invention. As shown, system 100 comprises caching mechanism 160 and various network devices, such as personal computer (PC) 110, server 120, cell phone 130, and tablet 140. Herein, the term network device refers to a device that queries a database according to embodiments of the present invention. The network devices shown in FIG. 1 may interface with a network 101, which may in turn interface with the Internet 150. Network 101 may comprise a local area network (LAN) or an intranet. Network 101 may comprise a network in various settings, such as a home, an enterprise, or an organization. Moreover, network 101 may comprise a wireless network. The devices shown in system 100 are exemplary and may be replaced, or accompanied by, additional network devices.

Cell phone 130 and tablet 140 are connected to network 101 over respective wireless connections. Cell phone 130 and tablet 140 may be limited-input devices. Other such limited-input devices may be connected to network 101, such as, for example, palm computing devices, TV-based Internet devices, and set-top boxes for messaging systems. In particular, Intel Corporation offers the Intel Tablet and Intel Dotstation, which may be appropriate for implementation in system 100.

Caching mechanism 160 comprises network interface 170, filter 180, and database 190. Network interface 170 monitors traffic on network 101. Such traffic may include any kind of network traffic, such as data transmissions relating to World Wide Web surfing, FTP (file transfer protocol) transfers, TCP (transmission control protocol) exchanges, and UDP (user datagram protocol) broadcasts. Network interface 170 may include a network adapter capable of operating in so-called “promiscuous mode,” wherein the adapter examines all packets of information flowing across network 101. That is, network interface 170 may examine packets associated with all network IDs, not simply the network ID associated with network interface 170. Alternatively, network interface 170 may monitor web traffic from specific nodes in network 101 instead of all nodes.

Network interface 170 may monitor network traffic while concurrently providing network functions to a hardware device, such as caching mechanism 160 or a client or server (not shown), that includes network interface 170. Thus, network interface 170 may passively monitor network traffic while performing additional tasks. In other embodiments (not shown), a user may enable or disable the monitoring of network traffic by network interface 170, and more generally, by caching mechanism 160.

Filter 180 extracts web addresses from the monitored traffic provided by network interface 170. Filter 180 may be implemented in software or hardware. In a software implementation, filter 180 may be realized in, for example, C or BASIC programming languages. Filter 180 may comprise a software agent running on a client computer. Filter 180 may examine the header of each packet provided by network interface 170. If a packet includes an HTTP (hypertext transfer protocol) header, then filter 180 may determine the destination URL (uniform resource locator) from the remainder of the packet.

Database 190 stores the web addresses extracted by filter 180. Database 190 may comprise a history cache relating to web surfing in a network such as network 101 in FIG. 1. In particular, database 190 may include a list of extracted web addresses that correspond to web address traffic monitored since initialization of database 190; traffic monitored within a defined window of time; or traffic monitored that falls within predetermined categories. Database 190 may be stored in volatile or nonvolatile memory, such as a CD-ROM. Thus, stored web addresses may be retrieved at a time in the near or distant future. Database 190 may be implemented in, for example, Microsoft SQL Server, MySQL, or another database language and management system.

Caching mechanism 160 may open up a socket in network 101. Accordingly, a network device, such as cell phone 130 or tablet 140 in network 101, may query database 190 of caching mechanism 160. The query may return zero or more web addresses, which may correspond to the web addresses extracted by filter 180.

A user of the network device may surf the web addresses returned by the query. The network device may display the web addresses in a graphical user interface (GUI), such as in a drop-down menu or in a list. An input mechanism, such as a touch screen, a stylus, a button, or a knob may be used to select a site to surf. Further, the network device may incorporate a Braille input/output mechanism or a text-to-speech engine and/or speech synthesizer.

In an exemplary implementation, one hardware device may comprise caching mechanism 160 and its constituent components, namely, network interface 170, filter 180, and database 190. In other embodiments, these components may be located in remote systems that are interconnected. Caching mechanism 160 may include an operating system such as Linux or another embedded operating system. In another embodiment, caching mechanism 160 may be realized in a set-top box arrangement. For example, a cable modem configured to provide gateway and Internet sharing functions may be utilized. Network devices, such as those shown in FIG. 1, may be interfaced with the cable modem.

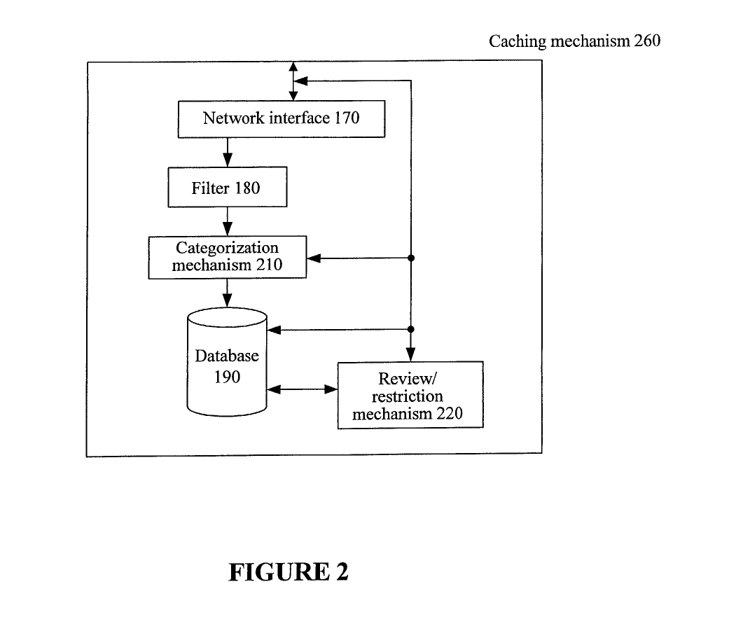

FIG. 2 is a high-level diagram illustrating a caching mechanism 260 according to another embodiment of the present invention. Caching mechanism 260 comprises a network interface 170, a filter 180, a categorization mechanism 210, a database 190, and a review/restriction mechanism 220. Network interface 170, filter 180, and database 190 are as described above.

Categorization mechanism 210 may sort or categorize web addresses in database 190. Categorization mechanism 210 may sort or categorize web addresses before or after the addresses are stored in database 190. The web addresses may be sorted according to one or more criteria. Such criteria may include any criterion defined in software, such as the time that a web address was visited, the date of a visit, the number of times visited (hit count), and content. Such sorting may facilitate a user's ability to surf recently visited websites or favorite websites.

Categorization mechanism 210 may categorize extracted web addresses provided by filter 180 based on one or more criteria, such as content. As such, categorization mechanism 210 may associate a web address with its respective content, such as news, research aids, or objectionable material. To assess the content of a site, categorization mechanism 210 may scan metatags of the site or the content of the site. In addition, categorization mechanism 210 may interface with a software application or a services provider, which may supply categorization mechanism 210 with a characterization of the site or allow a parent or administrator to supply the characterization.

Categorization mechanism 210 may inform a user if an extracted web address falls within a predetermined category. In an exemplary implementation, categorization mechanism 210 may send an e-mail message to a parent or administrator if an extracted web address falls within one or more categories prespecified by the parent, administrator, or a software application or services provider. The message sent by categorization mechanism 210 may also comprise an instant message sent to a limited-input device, such as cell phone in FIG. 1.

Review/restriction mechanism 220 may allow a user, such as a parent or administrator, to review the extracted web addresses. A parent or administrator may select zero or more of the extracted web addresses to become subject to a restriction. Review/restriction mechanism 220 may then restrict a second user, such as a child or an employee, from surfing the extracted web addresses subject to the restriction. Review/restriction mechanism 220 may perform the restriction itself. Alternatively, review/restriction mechanism 220 may convey the restriction information to another software or hardware device external to caching mechanism 260, which may then act as a content filter for a network, such as network 101 in FIG. 1.

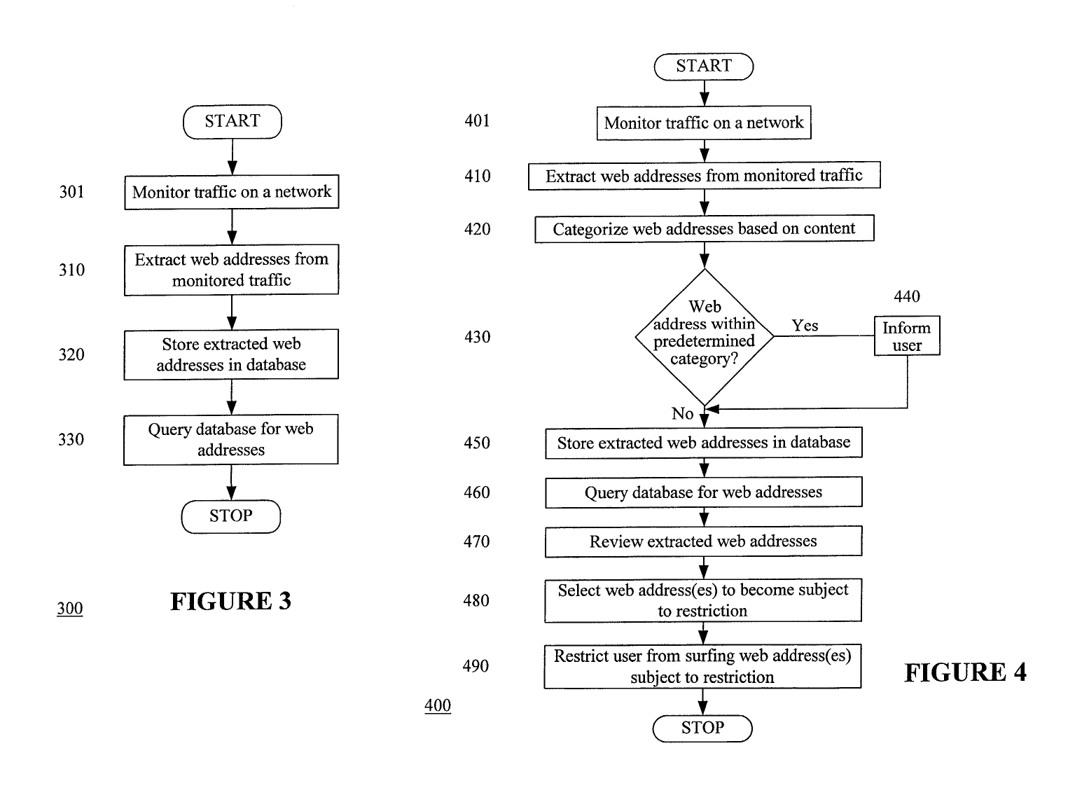

FIG. 3 is a high-level flow diagram of method 300 according to an embodiment of the present invention. In item 301, a network interface monitors traffic on a network. In item 310, a filter extracts web addresses from the monitored traffic. A database stores the extracted web addresses in item 320. In item 330, a network device queries the database. The querying returns zero or more web addresses to the network device, which a user or network device may then surf.

FIG. 4 is a high-level flow diagram of method 400 according to an embodiment of the present invention. In item 401, a network interface monitors traffic on a network. In item 410, a filter extracts web addresses from the monitored traffic. In item 420, a categorization mechanism categorizes the extracted web addresses based on their content. In item 430, the method tests whether each web address is in a predetermined category. If the answer is yes, then a user is informed, in item 440, that a web address is within a predetermined category. If the answer is no, then a database stores the extracted web addresses in a database in item 450.

In item 460, a network device queries the database. The query may return zero or more web addresses to the network device. In item 470, a user reviews the extracted web addresses. The user may select zero or more extracted web addresses to become subject to a restriction in item 480. For instance, the user may specify that a second user may only surf the web addresses at a certain time of day or that the second user may never surf the web addresses subject to the restriction. In item 490, the second user is restricted from surfing the web addresses that are subject to the restriction.

The foregoing description of the preferred embodiments is provided to enable any person skilled in the art to make or use the present invention. Various modifications to these embodiments are possible, and the generic principles presented herein may be applied to other embodiments as well. For instance, a limited-input device, such as tablet 140 in FIG. 1, may maintain a record of websites that the user surfs when the device interfaces with a network other than network 101. When the device interfaces with network 101 at a later date, the information may be uploaded to caching mechanism 160 or another device for review by a parent or administrator. Additionally, embodiments of the present invention need not be implemented with limited-input network devices.

In another embodiment, caching mechanism 160 may include an analyzer that analyzes the web addresses stored in database 190. For instance, the analyzer may generate bar graphs depicting hit count for each website or for websites falling within categories. In other embodiments, the user of a limited-input device may specify a query criterion when querying database 190. In particular, a family member may specify his or her name or user ID, and the associated web addresses may be returned to the limited-input device.

Moreover, the invention may be implemented in part or in whole as a hard-wired circuit, as a circuit configuration fabricated into an application-specific integrated circuit, or as a firmware program loaded into non-volatile storage or a software program loaded from or into a data storage medium as machine-readable code, such code being instructions executable by an array of logic elements such as a microprocessor or other digital signal processing unit.

As such, the present invention is not intended to be limited to the embodiments shown above but rather is to be accorded the widest scope consistent with the principles and novel features disclosed in any fashion herein.

What is claimed:

1. A method for caching web addresses comprising:
monitoring, by a network interface, traffic on a network;
extracting, by a filter, web addresses from the monitored traffic;
storing, by a database, the extracted web addresses; and
querying, by a network device, the database, the querying returning zero or more web addresses to the network device.

2. The method of claim 1, further comprising categorizing, by a categorization mechanism, the extracted web addresses based at least in part on content.

3. The method of claim 2, further comprising informing a user if an extracted web address falls within a predetermined category.

4. The method of claim 1, further comprising:
reviewing, by a user, the extracted web addresses;
selecting, by the user, zero or more extracted web addresses to become subject to a restriction; and
restricting a second user from surfing the extracted web addresses subject to the restriction.

5. The method of claim 1, wherein the network device includes one of an Internet tablet, a palm computing device, a cell phone, and a TV-based Internet device.

6. The method of claim 1, further comprising surfing, by the user, one among the zero or more web addresses.

7. The method of claim 1, wherein the querying includes downloading the zero or more web addresses when the network device is connected to the network.

8. The method of claim 1, further comprising:
displaying, by the network device, one among the zero or more web addresses; and
selecting, by a user, a web address among the displayed web addresses to surf.

9. The method of claim 8, wherein the one among the zero or more web addresses is displayed in a drop-down menu.

10. A method for caching web addresses comprising:
monitoring, by a network interface, traffic on a network;
extracting, by a filter, web addresses from the monitored traffic; and
storing, by a database, the extracted web addresses,
wherein a network device queries the database for zero or more web addresses.

11. The method of claim 10, wherein the monitoring comprises passively monitoring traffic.

12. The method of claim 10, further comprising enabling or disabling, by a user, the monitoring.

13. The method of claim 10, wherein the network comprises a network in a home.

14. The method of claim 10, wherein the network comprises a wireless network.

15. The method of claim 10, wherein the network comprises an intranet.

16. The method of claim 10, further comprising sorting the stored web addresses according to at least one criterion.

17. The method of claim 16, wherein the at least one criterion includes one of time, date, hit count, and content.

18. The method of claim 10, wherein the database comprises a history cache.

19. The method of claim 10, wherein the network device includes one of an Internet tablet, a palm computing device, a cell phone, and a TV-based Internet device.

20. A system for caching web addresses comprising:
a network interface configured to monitor traffic on a network;
a filter configured to extract web addresses from the monitored traffic;
a database configured to store the extracted web addresses; and
a network device configured to query the database, wherein the database query returns zero or more web addresses.

21. The system of claim 20, wherein the network comprises a local area network (LAN).

22. A system for caching web addresses comprising:
a network interface configured to monitor traffic on a network;
a filter configured to extract web addresses from the monitored traffic; and
a database configured to store the extracted web addresses,
wherein a network device queries the database for zero or more web addresses.

23. The system of claim 22, wherein one hardware device comprises the network interface, the filter, and the database.

24. The system of claim 22, wherein the network interface comprises a network adapter configured to operate in promiscuous mode.

25. The system of claim 22, wherein the filter comprises a software agent on a client.

26. A computer-readable medium having a plurality of processor-executable instructions for:
monitoring, by a network interface, traffic on a network;
extracting, by a filter, web addresses from the monitored traffic; and
storing, by a database, the extracted web addresses,
wherein a network device queries the database for zero or more web addresses.

27. The computer-readable medium of claim 26, wherein the monitoring comprises passively monitoring traffic.

28. A computer-readable medium having a plurality of processor-executable instructions for:
querying, by a network device, a database, the querying returning zero or more web addresses to the network device,
wherein a network interface monitors traffic on a network,
a filter extracts web addresses from the monitored traffic, and
a database stores the extracted web addresses.

29. The computer-readable medium of claim 28, further comprising processor-executable instructions for surfing, by the network device, one among the zero or more web addresses.
